(19) United States
(12) Patent Application Publication
(10) Pub. No.: US 2021/0034712 A1
(43) Pub. Date: Feb. 4, 2021

(54) DIAGNOSTICS FRAMEWORK FOR LARGE SCALE HIERARCHICAL TIME-SERIES FORECASTING MODELS

(71) Applicant: INTUIT INC., Mountain View, CA (US)

(72) Inventors: Sambarta DASGUPTA, Mountain View, CA (US); Colin R. DILLARD, Redwood City, CA (US); Sean ROWAN, San Francisco, CA (US); Shashank SHASHIKANT RAO, San Jose, CA (US)

(21) Appl. No.: 16/526,903

(22) Filed: Jul. 30, 2019

(51) Int. Cl. G06F 17/50

(52) U.S. Cl. CPC G06F 17/5009; G06F 2217/16

(57) ABSTRACT

Certain aspects of the present disclosure provide techniques for providing a diagnostics framework for large scale hierarchical time series forecasting models. In one embodiment, a method includes providing a plurality of hierarchical time-series, each of the plurality of hierarchical time-series comprising node data; concurrently providing node data from the plurality of hierarchical time-series to a forecasting model; using the forecasting model, concurrently calculating a plurality of forecasting data corresponding to each one of the node data of the plurality of hierarchical time-series; concurrently calculating a plurality of performance metrics of the forecasting model using the plurality of forecasting data; and generate an updated forecasting model by modifying the forecasting model based upon the plurality of performance metrics; concurrently calculating a plurality of updated forecasting data corresponding to each one of the node data using the updated forecasting model; and provide the updated forecasting data to a user.

### BACKGROUND

### Field

Embodiments of the present invention generally relate to measuring the quality of forecasting models.

### Description of the Related Art

Within the fields of data science, discrete and time-series data are used to determine or forecast future values, or probability distributions of values, of data under examination. Collected data are provided to a forecasting model to make these types of determinations. The data are typically from real events, such as financial transactions, demographics, scientific measurements, data related to the operation of a company or government; the sources of data are only limited by human ingenuity to generate it. Data may also be generated synthetically. A model may be developed in a manner that includes an understanding of the effects of real-world events, such that when data is provided to the model, the output is a useable approximation of a possible future value of a data type.

In a number of fields, data may be represented in a time-series; that is a series of data points placed in a temporal order. For example, financial management activity in an account may be represented as a time-series of individual transactions organized by the time of occurrence of the individual transactions. Similar organization of data in time-series may be found in signal processing, weather forecasting, control engineering, astronomy, communications, and other fields in which temporal measurements are useful. Time series forecasting uses models to predict future values of a time-series based upon previously observed values.

Models used in forecasting are evaluated in a manner that provides metrics that provide insight as to their performance. These performance metrics provide confidence to users in the forecasted values, or, with data-based insights that may be used to update the model so that its performance may be improved.

There are a number of approaches that evaluate the performance of models that predict time-series outputs. However, these approaches are unable to realistically evaluate models that make concurrent forecasts on large volumes of time-series data and across hierarchical time series, or require comparative evaluation of models across hierarchical time series data.

Accordingly, what is needed are systems and methods to effectively evaluate forecast model performance across large volumes of hierarchical time series data.

### BRIEF SUMMARY

Certain embodiments provide a method for evaluating of a system of models of a hierarchical time-series. In one embodiment, the method includes providing a plurality of hierarchical time-series, each of the plurality of hierarchical time-series comprising node data; concurrently providing node data from the plurality of hierarchical time-series to a forecasting model; using the forecasting model, concurrently calculating a plurality of forecasting data corresponding to each one of the node data of the plurality of hierarchical time-series; concurrently calculating a plurality of performance metrics of the forecasting model using the plurality of forecasting data; and generate an updated forecasting model by modifying the forecasting model based upon the plurality of performance metrics; concurrently calculating a plurality of updated forecasting data corresponding to each one of the node data using the updated forecasting model; and provide the updated forecasting data to a user.

Other embodiments provide a non-transitory computer-readable medium comprising instructions that, when executed by a processor of a processing system, cause the processing system to perform a method of evaluating performance of a system of models of a hierarchical time-series, comprising: providing a plurality hierarchical time-series each of the plurality of hierarchical time-series comprising node data; concurrently providing node data from the plurality of hierarchical time-series to a forecasting model; using the forecasting model, concurrently calculating a plurality of forecasting data corresponding to each one of the node data of the plurality of hierarchical time-series; concurrently calculating a plurality of performance metrics of the forecasting model using the plurality of forecasting data; generating an updated forecasting model by modifying the forecasting model based upon the plurality of performance metrics; concurrently calculating a plurality of updated forecasting data corresponding to each one of the node data using the updated forecasting model; and providing the update forecasting data to a user.

Other embodiments provide a system for evaluating performance of a system of models of a hierarchical time-series, comprising a memory comprising computer-readable instructions; a plurality of hierarchical time-series each of the plurality of hierarchical time-series comprising a node, each node comprising node data; a forecasting model; a plurality of performance metrics; a processor configured to calculate concurrently a plurality of forecasting data using node data corresponding to a node, each one of the plurality of forecasting data corresponding to a respective node; calculate concurrently the plurality of performance metrics of the forecasting model based upon the plurality of forecasting data; generate an updated forecasting model by modeling the forecasting model based upon the plurality of performance metrics; calculated concurrently a plurality of updated forecasting data corresponding to each one of the node data using the updated forecasting model; and provide the updated forecasting data to a user.

### BRIEF DESCRIPTION OF THE DRAWINGS

The appended figures depict certain aspects of the one or more embodiments and are therefore not to be considered limiting of the scope of this disclosure.

FIG. 1A is an exemplary depiction of time-series hierarchical data set according to an embodiment.

FIG. 1B is an exemplary depiction of a plurality of time-series hierarchical data sets according to an embodiment.

FIG. 2 is an exemplary depiction of an architectural diagram of a diagnostics framework for large scale hierarchical time-series forecasting models, according to an embodiment.

FIG. 3 depicts an exemplary dataset used in conjunction with normalizing a Quantile-Loss function, according to embodiments.

FIG. 4 depicts an exemplary dataset used in conjunction with normalizing a Quantile-Loss function, according to embodiments.

FIG. 5 depicts an exemplary data plot of mean-standard deviation pairs used in conjunction with normalizing a Quantile-Loss function, according to embodiments.

FIG. 6 depicts an example method of operating diagnostics framework system for large scale hierarchical time-series forecasting models.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

In the following, reference is made to embodiments of the disclosure. However, it should be understood that the disclosure is not limited to specifically described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments, and advantages are merely illustrative and are not considered elements or limitations of the appended claims except where explicitly recited in a claim(s). Likewise, a reference to “the disclosure” shall not be construed as a generalization of any inventive subject matter disclosed herein and shall not be considered to be an element or limitation of the appended claims except where explicitly recited in a claim(s).

Aspects of the present disclosure provide apparatuses, methods, processing systems, for a diagnostics framework for large scale time-series forecasting models.

A framework is disclosed to evaluate the performance of one or more models used to forecast values for a hierarchical structure of a large number of time-series with non-homogeneous characteristics (e.g., potentially having sparse, multi-periodic, and non-stationary data). There is a need, for example, in large scale cash flow forecasting, to forecast financial health data for millions of companies. Each company has financial data structured as multiple hierarchical time-series representing different financial accounts and their associated activities, which are in turn aggregated to represent revenue, profit, income, expenses, and other indicators of the financial health of a respective company. Although this example contemplates businesses, the present disclosure is similarly applicable to the finances of individuals, governments, or other entities. Moreover, embodiments disclosed herein are not limited to the company of finance and are applicable to any endeavor in which a large volume of hierarchical time-series are modeled for forecasting.

Prior approaches, carried out primarily in academia, or otherwise using a small number of time-series, lack an appreciation for diagnosing forecasting models of many companies (e.g., millions), and concomitantly, large numbers of hierarchical time-series. These prior approaches rely on a small number of metrics, and relatively rich time-series data, as opposed to the sparse, multi-periodic, and non-stationarity of real-world time-series data. Prior approaches lack the ability to compare diagnostic metrics across multiple hierarchical time-series/multiple companies at scale (e.g., millions of time-series associated with millions of companies). In the context of non-homogeneous data and scale, prior approaches are unable to successfully diagnose root causes behind poor forecast model performance. Finally, prior approaches don't develop metrics that contemplate inconsistencies within a hierarchical time-series and/or across multiple hierarchical time-series.

To address these shortcomings, embodiments of the disclosed framework compute forecasting model metrics at different levels of a hierarchical time-series to provide insight into model performance. The metrics are normalized such that they may be compared across companies.

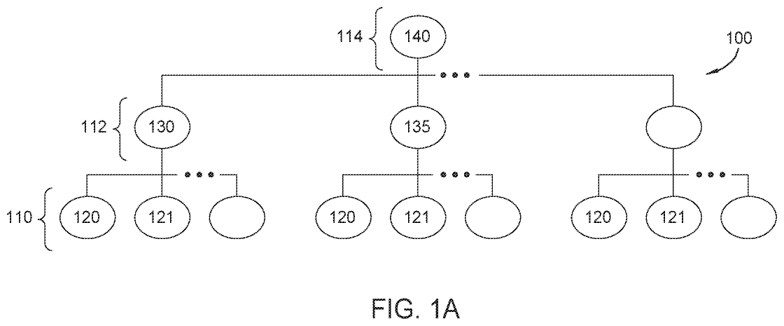

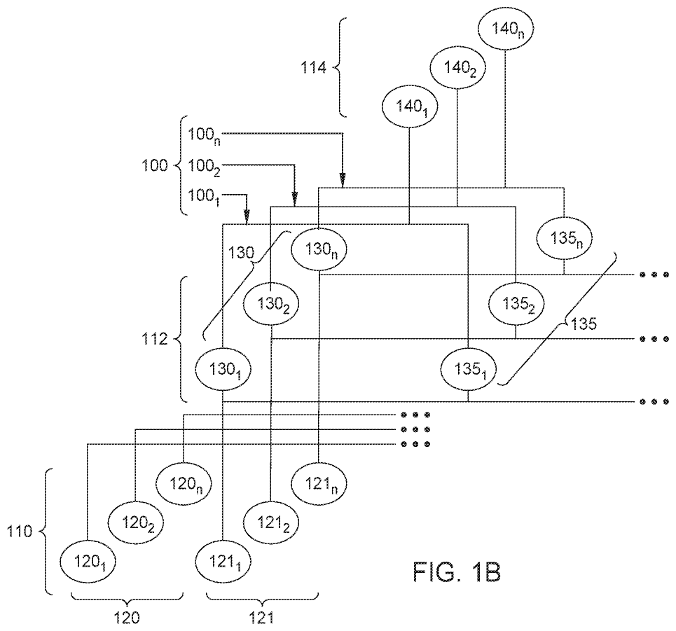

FIG. 1A depicts an exemplary time-series hierarchical data set according to one embodiment. Hierarchical time-series 100 in some embodiments is a hierarchical data model comprised of stream nodes 110, aggregate nodes 112, and a top-level aggregate node 114.

Stream nodes 110 represent a level of the hierarchical time-series 100 of collected data in the form of time-series data representing temporally related data, according to an embodiment. By way of example, in the company of financial management, stream nodes 110 could represent a series of transactions within a financial account. These transactions could be related to income, expenses, sales, revenue, profit, taxes, debt, or any financial activity resulting in a change of a financial account of a company, individual, or other entity. One of skill in the art will appreciate that time-series data may be generated and collected similarly in a wide range of endeavors, such as signal processing, weather forecasting, control engineering, astronomy, communications, physics, chemistry, queueing, etc., to which the techniques disclosed herein may be similarly applicable. It should also be noted that although time-series data is discussed herein, discrete values, vectors, matrices, distributions, functions, or other representations of discrete or grouped data values may be used without departing from the spirit or scope of this disclosure.

Stream node data 120, 121, 122, represents data within an individual stream node 110. Stream node data 120, 121, 122 in embodiments is represented by hierarchical time-series of temporally related values. In financial management, these could be a series of credit or debit transactions that may be related to purchase, sales, debt payments, tax payments, correctional payments, fees, fines, or any other activity that may reflect a change in a financial account. One of skill in the art will appreciate that the techniques used herein may be applied to any field of endeavor that uses data represented as a time-series. Although only three individual stream nodes 110 having stream node data 120, 121, 122 are shown in the exemplary configuration of hierarchical time-series 100, it is understood that hierarchical time-series 100 may be configured to have any number of stream nodes 110, and any number of stream nodes 110 depending from intermediate nodes of the hierarchical time-series 100.

Aggregate nodes 112 represent a level of the hierarchical time-series that is a combination of stream nodes 110 that depend from a particular aggregate node 112, according to some embodiments, with aggregate node data 130, 135 representing data within a particular aggregate node 112. For example, in financial management, an aggregate node 112 may represent a combination of activity represented by dependent stream nodes 110 in a particular financial account of a company, person, or entity. For example, aggregate node 112 may represent an individual financial account (e.g. checking, savings, investment, mortgage, credit card accounts, etc.), or for business and governmental entities, accounting accounts (e.g. sales, expenses, revenue, funding accounts, etc.) Aggregate node data 130 in embodiments is the aggregate combination stream node data 120, 121, 122, that may be combined in a manner determined by one skilled in the art. In financial management, for example, combining stream node data 120, 121, 122 may be additive. However, in some embodiments, stream nodes data 120, 121, 122 may be combined via subtraction, multiplication, division, composition, convolution, or other methods appropriate for stream node data 120, 121, 122.

Although three aggregate nodes 112 are shown in the exemplary configuration of hierarchical time-series 100, it is understood that the hierarchical time-series 100 may be configured to have any number of aggregate nodes 112, and any number of aggregate nodes 112 dependent from other nodes of the hierarchical time-series.

Although aggregate nodes 112 are shown as one level of hierarchical time-series 100, in some embodiments aggregate nodes 112 may themselves be child-nodes to other aggregate nodes 112, effectively adding aggregate node 112 layers (not shown) into the hierarchical time-series 100. Continuing with the financial management example, an additional aggregate node 112 level may represent an aggregation of financial accounts, may represent a sum of a balance across multiple bank accounts, total expenses, total sales/income, etc., that may be utilized by a company, person, or other entity.

Top level aggregate node 114, in some embodiments, represents a level of the hierarchical time-series 100 of an aggregation of the aggregate nodes 112. In the example of financial management, top-level aggregate node 114 may represent a summary of all financial activity, or category of financial activity, of a company, person, or other entity, such as net income, profit, net cash flow, revenue, etc. In some embodiments, there may be more than one top-level aggregate node, similarly configured to top-level aggregate node 114 (e.g., has dependent aggregate nodes 112). The aggregation of aggregate nodes 112 data into top-level aggregate node 114 may be any type of combination, as discussed above: additive, subtractive, multiplicative, divisional, compositional, convolutional, or other operation that may be performed on the data value of the aggregate nodes 112. Top level aggregate node data 140 represents data within top-level aggregate node 114, for example, combined data from aggregate node data 130 and 135.

FIG. 1B is an exemplary depiction of a plurality of a hierarchical time-series according to an embodiment. In some embodiments, the techniques disclosed herein may be used across multiple hierarchical time-series 100, comprised of hierarchical time-series 100₁, 100₂, 100ₙ. Each hierarchical time-series 100, having stream nodes 110 with stream node data 120 (e.g. 120₁, 121₂, 122ₙ), aggregate nodes 112, with aggregate node data 130 (e.g. 130₁, 130₂, 130ₙ, 135₁, 135₂, 135ₙ), and top-level aggregate node 114, with top-level aggregate node data 140 e.g. (140₁, 140₂, 140ₙ), that may be configured in a manner similar to hierarchical time-series 100 described above, and in embodiments each containing different data for a different company, person, or other entity.

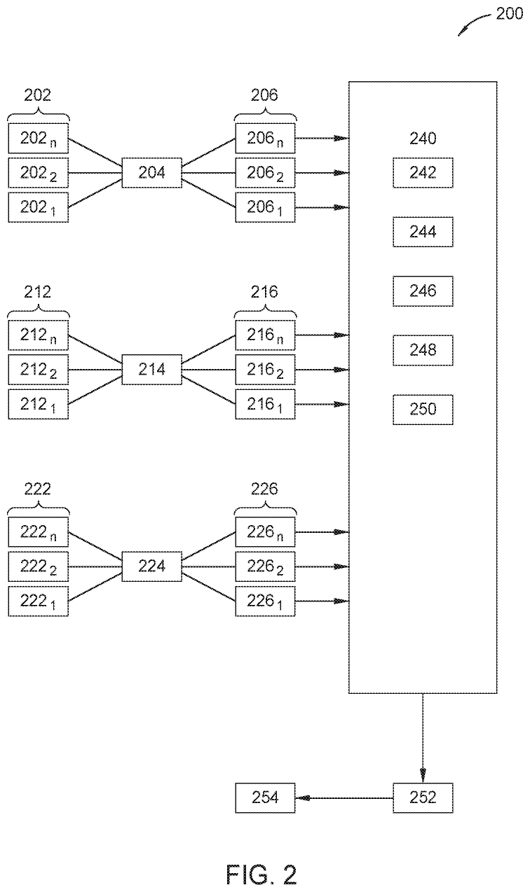

FIG. 2 is an exemplary depiction of an architectural diagram of a diagnostics framework 200 for large scale hierarchical time-series forecasting models, according to an embodiment.

Diagnostics framework 200 may comprise stream node data input 202 (202₁, 202₂, 202ₙ), which take data of one or more of stream nodes 110, stream forecasting model 204, and stream forecast data 206 (206₁, 206₂, 206ₙ). Stream node data inputs 202, in some embodiments, includes stream node data 120 from single or multiple hierarchical time-series 100 of FIG. 1B. In some embodiments, stream forecast data 206 is generated concurrently for multiple hierarchical time-series. Stream node data input 202 is provided to stream forecasting model 204 in order to develop forecast values of stream node data input 202, 202n.

Stream forecasting model 204 may be any type of model capable of taking stream node data inputs 202 as input and developing a forecast of that data. Exemplary types of models that may be used for stream forecasting model 204 include statistical models such as ARIMA, exponential smoothing, Theta method; machine learning models such as regression; general classes of deep learning models such as RNN, LSTM; particular deep learning models such as

MQ-RNN, DeepAR, and AR-MDN. Stream forecasting model 204 provides stream forecast data 206 as input to diagnostic metrics 240 for each respective stream node data input 202 provided.

Diagnostics framework 200 may further comprise aggregate node data inputs 212 (212₁, 212₂, 212ₙ) that takes data of one or more aggregate nodes 112, aggregation forecasting model 214, and aggregation forecast data 216 (216₁, 216₂, 216ₙ). Aggregate node data input 212 in some embodiments, includes aggregate node data 130 from single or multiple hierarchical time-series 100 of FIG. 1B. In some embodiments, aggregation forecast data 216 is generated concurrently for multiple hierarchical time-series. Aggregate node data 130 is provided as input to an aggregation forecasting model 214. Aggregation forecasting model 214 may be any type of model capable of taking aggregate node data 130 as input and developing a forecast of that data. Exemplary types of models that may be used for aggregate forecasting model 214 include statistical models such as ARIMA, exponential smoothing, Theta method; machine learning models such as regression; general classes of deep learning models such as RNN, LSTM; particular deep learning models such as MQ-RNN, DeepAR, and AR-MDN. Aggregate forecasting model 214 provides aggregate forecast data 216 as input to the diagnostic metrics 240 for each respective aggregate node data 130 provided.

Diagnostics framework 200 may further comprise top-level aggregate node data inputs 222 (222₁, 222₂, 222ₙ) that takes data from top-level aggregate nodes 114, top-level aggregate forecasting model 224, and top-level aggregation forecast data 226 (226₁, 226₂, 226ₙ). Top level aggregate node data inputs 222 in some embodiments, includes top-level aggregate node data 140 from multiple hierarchical time-series 100 of FIG. 1B. In embodiments, top-level aggregation forecast data 226 is generated concurrently for multiple hierarchical time-series. Top level aggregate node data 140 is provided as input to a top-level aggregate forecasting model 224. Top level aggregate forecasting model 224 may be any type of model capable of taking top-level aggregate node data as input and developing a forecast of that data. Exemplary types of models that may be used for top-level aggregate forecasting model 224 include statistical models such as ARIMA, exponential smoothing, Theta method; machine learning models such as regression; general classes of deep learning models such as RNN, LSTM; particular deep learning models such as MQ-RNN, DeepAR, and AR-MDN. Top level aggregate forecasting model 224 provides top-level aggregate forecast data 226 as input to the diagnostic metrics 240 for each top-level aggregate node data 140 provided.

Diagnostics framework 200 may further comprise diagnostics metrics 240. In some embodiments, diagnostics metrics 240 includes stream metrics 242, factor metrics 244, forecast consistency metrics 246, a north-star metric 248, and computational time metrics 250.

Stream metrics 242 take as input stream forecast data 206 to determine the performance of stream forecasting model 204. Stream metrics 242 may include standard metrics such as normalized Root Mean Square Error (nRMSE), RMSE, residual auto-correlation, R-Squared, residual standard error (RSE), mean absolute error (MAE), among others, for use with regression type models for stream forecasting model 204. In some embodiments special purpose metrics, like error in estimating Fourier modes, may be used to evaluate performance of some time-series models, for example, to detect periodicity.

In embodiments, stream metrics 242 for particular stream forecast data 206, such as based upon stream node data 120 of FIG. 1B, are normalized so that they may be compared to stream metrics 242 of stream forecast data 206n based upon data from other stream nodes, such as stream node data 121 of hierarchical time-series 100, or stream node data 120, from single or multiple hierarchical time-series 100 of FIG. 1B. By normalizing multiple stream metrics 242 that are derived from different stream forecast data 206, the stream forecasting model 204 may be evaluated, and as appropriate, modified.

Factor metrics 244 are computed disambiguate various effects contributing to the north-star metric 248 discussed below. They are applied to diagnose model performance for root causes of poor model performance of the stream forecasting model 204, the aggregation forecasting model 214, and/or the top-level aggregation model 224. Factor metrics 244 determine root causes from factors such as error in bias estimation (including, raw bias error and magnitude of bias error), error in variance estimation, and sharpness of the predicted distribution. One of skill in the art will appreciate that factor metrics 244 may be selected for the application at hand, for example, if there is concern with particular quantiles of interest in a particular forecast distribution, and instead of analyzing one standard deviation to evaluate variance, other quantiles may be analyzed. In some embodiment factor metrics 244 may include normalized mean error, marginal Q-Loss, mean error, absolute mean error, marginal q-loss, confidence interval coverage, entropy, gini score, and inter-quantile range, etc.

In embodiments, factor metrics 244 calculated for a particular aggregation forecast data 216 such as based on aggregate node data 130 of FIG. 1B, are normalized so that they may be compared to factor metrics 244 of aggregation forecast data based upon data from other stream nodes such as aggregate node data 135 of the same hierarchical time-series 100 or from aggregate nodes from a different hierarchical time-series 100. By normalizing multiple factor metrics 244 that are derived from different aggregate forecast data 216, 216n, the aggregation forecasting model 214 may be further evaluated by computing additional factor metrics 244, and as appropriate, modified.

Forecast consistency metrics 246 are computed to determine the consistency between forecast data of at least two different forecast models, to ensure that forecast data is consistent as between different levels of the same hierarchical time-series. Consistency is measured relative to the expected relationships defined in the hierarchy, such as addition, subtraction, multiplication, division, composition, convolution, or other methods appropriate for time series data. In some embodiments, a metric such as the L2 norm of the mean error of the forecast data for two time-series hierarchies may be used to compute forecast consistency metrics 246. Other forecast consistency metrics 246 may include L1/L-infinity norms of the inconsistencies of the mean forecasts across hierarchies.

The north-star metric 248 is computed based upon the top-level aggregation forecast data 226 in order to summarize the overall accuracy of all forecast data. In embodiments, the north-star metric may capture a variety of qualities of the forecasted distribution, such as calibration bias, calibration variance, and sharpness concurrently. In some embodiments north-star metric 248 is computed using normalized Quantile Loss (Q-Loss), while in other embodiments, Log-Likelihood or Continuous Ranked Probability Score (CRPS) may be utilized. Other metrics may be chosen by one skilled in the art, depending upon the data they're seeking to forecast, and in such embodiments the north-star metric 248 is chosen so as to capture as many qualities as possible from: calibration bias, calibration variance, sharpness, if the metric is absolute, comparable across entities/discrete time-series hierarchies, easily interpretable, non-parametric, invariant to mean shift, and invariance to scaling. After evaluating a host of metrics over these desired characteristics, it was found that normalized Q-Loss possesses more of the desired qualities in compared to the other metrics. Thus, for disclosed embodiments, it was chosen as the north-star metric.

In some embodiments of north-star metric 248, Q-Loss is normalized, or scaled, so that a one-sample Q-Loss metric may be applied to samples generated by time-series data at varying scales. For example, financial time-series data samples generated by a company with $100 million per year annual revenue would vary dramatically in scale from a company with $1000 per year in annual revenue. This difference in scale, if not normalized, would result in metrics heavily influenced by the company with the larger annual revenue. As would be appreciated by one skilled in the art, scaling of metrics cannot be based upon any feature of the forecast data, as such a scaled metric would incur inherent calibration or sharpness estimation bias.

In some embodiments a function regression technique to normalize, or scale, Q-Loss may be used that estimates the normalization (or scale) factor for a single sample observation. This may be achieved by regression on a validation dataset. The data points in the validation dataset are grouped into clusters, each of which is assumed to correspond to a generating distribution. Within each cluster, the collection of historic validation data (e.g., the historic time-series in the case of cash flow forecasting) is used to estimate a mean and standard deviation for the corresponding distribution. The pairs of mean-standard deviation parameters from across the set of clusters form a set of points in 2D space, upon which a regression model is trained to predict the standard deviation as a function of the mean. The regression model is applied to each new observation to predict the corresponding normalization/scale parameter, which is used to normalize the Q-Loss metric for the corresponding forecast.

By way of example, generating a normalization factor for Q-Loss so that it may be used as the north-star metric 248 will be discussed, in the context of company profit. In embodiments, a way to scale may be represented by:

Q_{L}/β.|y|+α′ (1)

In Equation 1, Q_{L}, is the Q-Loss function, y is the observed profit for a month, and α, β are constants. This is linear scaling. The parameters α, β would be determined by the fitted regression model. When scaling in this manner, in embodiments a is non-zero, to avoid division by zero at y=0. Next, historical data is analyzed to find the appropriate scaling/normalization factor for each company being observed. The scaling factor is to be expressed as a linear function of observation and should be an estimate of the standard deviation of the profit for a company.

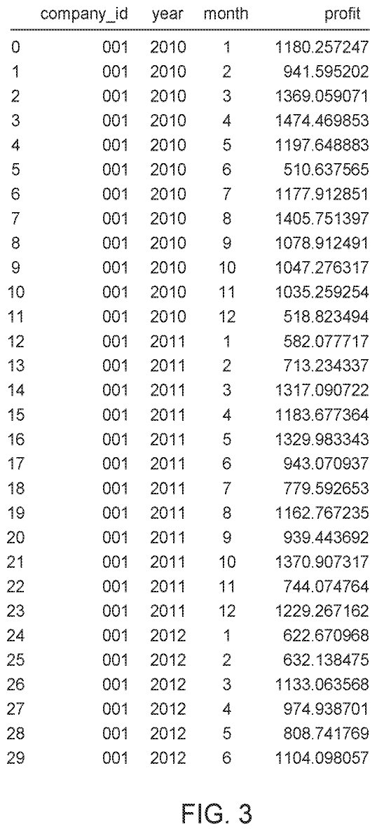

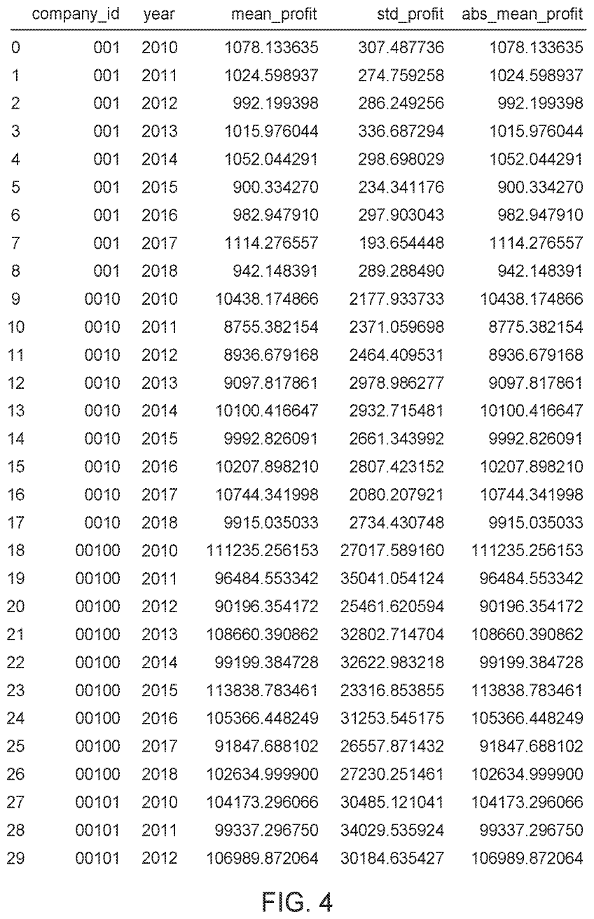

From a sample dataset, monthly profit is computed for each company_ID of FIG. 3, resulting in a set of profit values (by month) for each company, depicted in FIG. 3. For each company, the mean and standard deviation of the monthly profits are calculated. This results in a pair of points (mean, standard deviation) for each company, as shown in FIG. 4.

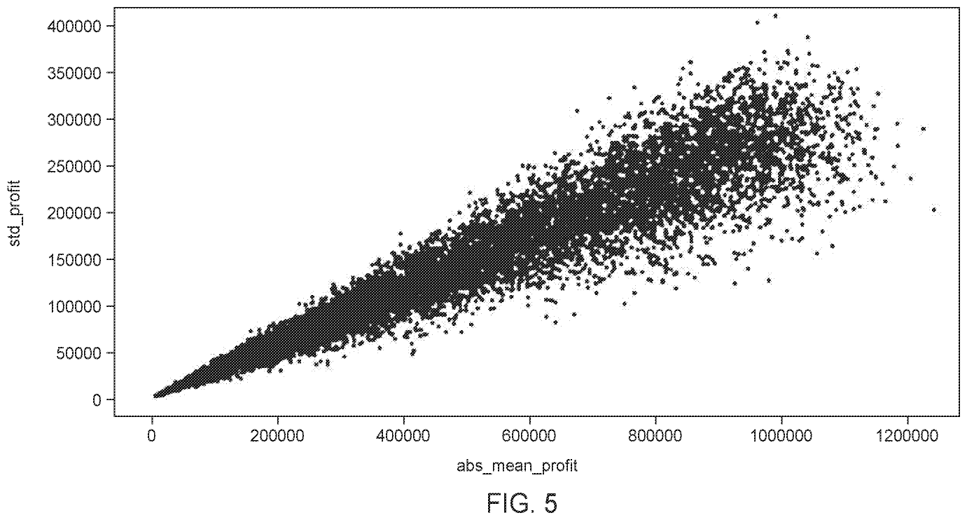

The plot of FIG. 5 shows log standard deviation profit at company level (x-axis) and mean profit at company level (y-axis). A linear regression is done to model standard deviation as a function of the mean (m) in the following:

\hat{δ}=β|m|+α (2)

From the least squares fit (for the synthetic example provided in the FIGS. 3, 4, 5):
α=1.0
β=0.0

\hat{δ} may be a valid scaling factor, and thus Equation 1 may be used to scale/normalize Q-Loss, when used as the north-star metric 248. One skilled in the art will appreciate that a similar normalization technique may be used with other metrics suitable for use as the north-star metric 248.

Returning now to the example of FIG. 2, in embodiments, diagnostic metrics 240 may further comprise computational time metrics 250, which are used to compute computational time costs for running forecasting and aggregation steps. Exemplary metrics for use as computational time metrics 250 include total time, mean time, median time or P50, P90, P99, etc.

In some embodiments, diagnostic framework 200 further includes a statistical test 252 portion. Statistical tests 252 are performed on the various metrics contemplated herein, or equivalents and alternatives thereto, to compare the performance of the models disclosed. By way of example, statistical tests that may be used to compare model performance as part of statistical tests 252 include Kolmogorov Smirnov test, to compare a sample with a reference probability distribution, or to compare two samples; Cliff's delta, Cohen's D coefficients, z-test, and t-test may be used to characterize improvements in the values of metrics. In some embodiments, to apply one or more statistical tests 252, each metric measurement is normalized across companies in order to allow for meaningful comparison.

Once one or more of the metrics discussed above is determined, in embodiments, one or more of the forecasting models may be updated based upon the metrics.

In yet further embodiments, diagnostics framework 200 includes a dashboard 254, upon which the hierarchical time-series and/or their nodes, models, forecast data, or metrics may be displayed to a user, enabling the user to modify, perform operations upon, or combine any of these.

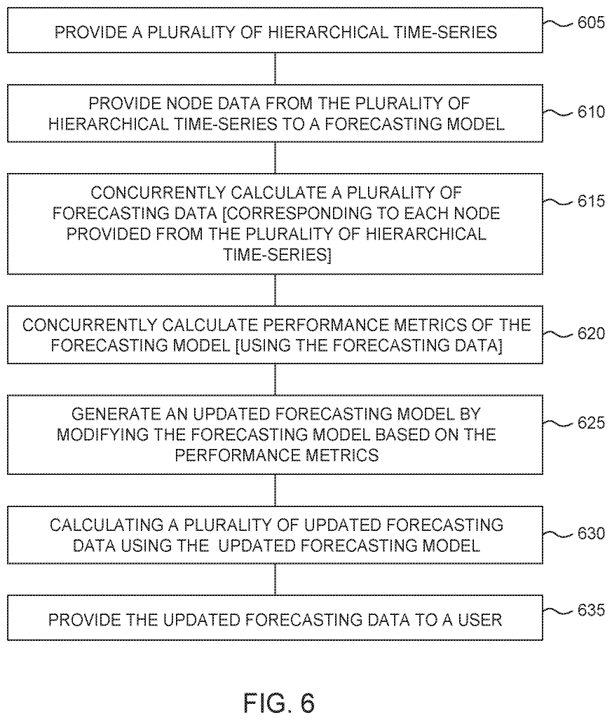

FIG. 6 depicts a method 600 of operating diagnostics framework system for large scale hierarchical time-series forecasting models.

At 605, one or more hierarchical time-series are provided. The hierarchical time-series data structure in this context may include structures similar to those depicted in FIG. 1A or 1B and the related description above.

At 610, node data from the plurality of hierarchical time-series are provided to a forecasting model. In some embodiments, these forecasting models may be one or more of stream forecasting model 204, aggregation forecasting model 214, and top-level forecasting model 224.

At 615, a plurality of forecasting data corresponding to each node provided from the plurality of hierarchical time-series is concurrently calculated.

At 620, performance metrics of the forecasting model generating the forecasting data is concurrently calculated.

At 625, the forecasting model is updated based on the performance metrics.

At 630, updated forecasting data is calculated using the updated forecasting model.

At 635, the updated forecast is provided to a user.

At 665, statistical tests are performed based upon the generated metrics.

Finally, at 670, data, aggregation, models, metrics, and results may be displayed to a user via diagnostic dashboard.

In some embodiments, method 600 may further comprise: providing a second node data from the plurality of hierarchical time-series to a second forecasting model, the second forecasting model calculating a second plurality of forecasting data corresponding to each one of the second node data from the plurality of hierarchical time-series; calculating a consistency metric as between the forecasting data and the second forecasting data; and modifying or of the forecasting model and the second forecasting model based upon the consistency metric.

In some embodiments, method 600 may further comprise: normalizing the performance metrics before modifying the forecasting model. In some embodiments, normalizing the metrics further comprises using a function regression that estimates normalization from a single sample observation. In some embodiments, method 600 may further comprise: generating a means-scale parameter pairs upon which the function regression is trained.

In some embodiments, the node data is stream data comprising time-series data.

In some embodiments, the plurality of performance metrics comprise a metric from one of stream metrics, factor metrics, forecast consistency metrics, north-star metrics, computational time metrics, and statistical tests.

Notably, method 600 is just one example, and other examples are possible based on the methods described herein.

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g.,, a-a, a-a-a, a-a-b, a-a-c, a-b-b, a c c, b-b, b-b-b, b-b-c, c-c, and c-c-c or any other ordering of a, b, and c).

As used herein, the term “concurrently” or “concurrent” refers to actions taken in parallel that do not need to necessarily begin or end at the same time.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. One of skill in the art will appreciate that one or more components coupled by the bus may be alternatively coupled via a network (e.g., for full or partial implementations of a processing system in a distributed or cloud environment). A user interface (e.g., keypad, display, mouse, joystick, etc.) may also be connected to the bus. The bus may also link various other circuits such as timing sources, peripherals, voltage regulators, power management circuits, and other circuit elements that are well known in the art, and therefore, will not be described any further. The processor may be implemented with one or more general-purpose and/or special-purpose processors, and may in some embodiments represent multiple processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates the transfer of a computer program from one place to another. The processor may be responsible for managing the bus and general processing, including the execution of software modules stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer-readable storage medium with instructions stored thereon separate from the wireless node, all of which may be accessed by the processor through the bus interface. Alternatively, or in addition, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for evaluating performance of a system of models of a hierarchical time-series, comprising:
providing a plurality of hierarchical time-series, each of the plurality of hierarchical time-series comprising node data;
concurrently providing node data from the plurality of hierarchical time-series to a forecasting model;
concurrently calculating, using the forecasting model, a plurality of forecasting data corresponding to each one of the node data of the plurality of hierarchical time-series;
concurrently calculating a plurality of performance metrics of the forecasting model using the plurality of forecasting data;
updating the forecasting model by based upon the plurality of performance metrics;
concurrently calculating a plurality of updated forecasting data corresponding to each one of the node data using the updated forecasting model; and
providing the updated forecasting data to a user.

2. The method of claim 1, further comprising:
providing a second node data from the plurality of hierarchical time-series to a second forecasting model, the second forecasting model calculating a second plurality of forecasting data corresponding to each one of the second node data from the plurality of hierarchical time-series;
calculating a consistency metric as between the forecasting data and the second forecasting data; and
modifying or of the forecasting model and the second forecasting model based upon the consistency metric.

3. The method of claim 1, further comprising: normalizing the performance metrics before modifying the forecasting model.

4. The method of claim 3, wherein normalizing the metrics further comprises using a function regression that estimates normalization from a single sample observation.

5. The method of claim 4, further comprising: generating a means-scale parameter pairs upon which the function regression is trained.

6. The method of claim 1, wherein the node data is stream data comprising time-series data.

7. The method of claim 1, wherein the plurality of performance metrics comprise a metric from one of stream metrics, factor metrics, forecast consistency metrics, north-star metrics, computational time metrics, and statistical tests.

8. A non-transitory computer-readable medium comprising instructions that, when executed by a processor of a processing system, cause the processing system to perform a method of evaluating performance of a system of models of a hierarchical time-series, comprising:
providing a plurality hierarchical time-series each of the plurality of hierarchical time-series comprising node data;
concurrently providing node data from the plurality of hierarchical time-series to a forecasting model;
using the forecasting model, concurrently calculating a plurality of forecasting data corresponding to each one of the node data of the plurality of hierarchical time-series;
concurrently calculating a plurality of performance metrics of the forecasting model using the plurality of forecasting data;
generating an updated forecasting model by modifying the forecasting model based upon the plurality of performance metrics;
concurrently calculating a plurality of updated forecasting data corresponding to each one of the node data using the updated forecasting model; and
providing the update forecasting data to a user.

9. The non-transitory computer-readable medium of claim 8, further comprising:
providing a second node data from the plurality of hierarchical time-series to a second forecasting model, the second forecasting model calculating a second plurality of forecasting data corresponding to each one of the second node data from the plurality of hierarchical time-series;
calculating a consistency metric as between the forecasting data and the second forecasting data; and
modifying or of the forecasting model and the second forecasting model based upon the consistency metric.

10. The non-transitory computer-readable medium of claim 8, further comprising:
normalizing the performance metrics before modifying the forecasting model.

11. The non-transitory computer-readable medium of claim 10, wherein normalizing the metrics further comprises a function regression that estimates normalization from a single sample observation.

12. The non-transitory computer-readable medium of claim 11, further comprising:
generating a means-scale parameter pairs upon which the function regression is trained.

13. The non-transitory computer-readable medium of claim 8, wherein the node data is stream data comprising time-series data.

14. The non-transitory computer-readable medium of claim 8, wherein the plurality of performance metrics comprise a metric from one of stream metrics, factor metrics, forecast consistency metrics, north-star metrics, computational time metrics, and statistical tests.

15. A system for evaluating performance of a system of models of a hierarchical time-series, comprising:
a memory comprising:
computer-readable instructions;
a plurality of hierarchical time-series each of the plurality of hierarchical time-series comprising a node, each node comprising node data;
a forecasting model; and
a plurality of performance metrics;
a processor configured to:
calculate concurrently a plurality of forecasting data using node data corresponding to a node, each one of the plurality of forecasting data corresponding to a respective node;
calculate concurrently the plurality of performance metrics of the forecasting model based upon the plurality of forecasting data;
generate an updated forecasting model by modeling the forecasting model based upon the plurality of performance metrics;
calculate concurrently a plurality of updated forecasting data corresponding to each one of the node data using the updated forecasting model; and
provide the updated forecasting data to a user.

16. The system of claim 15, wherein:
the memory further comprises:
a second node data from the plurality of hierarchical time-series;
a second forecasting model; and
a consistency metric;
the processor is further configured to:
calculate a second plurality of forecasting data using the second node data;
calculate the consistency metric using the plurality forecasting data and the second plurality of forecasting data; and
modify one of the forecasting model and second forecasting model based upon the consistency metric.

17. The system of claim 15, wherein the processor is further configured to normalize the performance metrics before modifying the forecasting model.

18. The system of claim 17, wherein normalizing the metrics further comprises the processor being configured to perform a function regression that estimates normalization from a single sample observation.

19. The system of claim 15 wherein the node data comprises time-series data.

20. The system of claim 15, wherein the plurality of performance metrics comprise a metric from one of stream metrics, factor metrics, forecast consistency metrics, north-star metrics, computational time metrics, and statistical tests.
